(19) United States
(12) Patent Application Publication
(10) Pub. No.: US 2008/0046891 A1
(43) Pub. Date: Feb. 21, 2008

(54) Cooperative asymmetric multiprocessing for embedded systems

(76) Inventors: Jayesh Sanchorawala, Albuquerque, NM (US); Scott R. Maass, Rio Rancho, NM (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/485,400

(22) Filed: Jul. 12, 2006

(51) Int. Cl. G06F 9/46

(52) U.S. Cl. 718/104

(57) ABSTRACT

Cooperative Asymmetric Multiprocessing allows for operating systems to function independently of each other on multiple processors sharing common resources in an embedded system. However, some degree of cooperation is required because there are resources with single instances shared across both cores, such as interrupt controller, boot sequencer, DMA engines, etc. The ability to support two distinct operating systems independently gives valuable flexibility. This method allows for reduced complexity in a multi processor system and allows use of existing tools with minimal modifications.

### BACKGROUND OF THE INVENTION

1. Field of the Invention (Technical Field)

The invention relates to embedded software development for multi-processors and more particularly to a method and apparatus for providing operating systems running on two independent processors that share resources, namely a single memory space.

2. Background Art

There existed a need for an implementation to have operating systems running on two independent processors that share a single memory space. The industry trend is for multiple processors and multiple cores. There are numerous advantages of multiple processors including reduced heat and task sharing. The operating systems should function independent of each other. The two processors should also have a common system controller and the same interrupt vector locations. A boot (startup) sequence needs to allow both processors to use the same reset vector in flash. The prior art embedded operating systems are not designed to support multiple processors that share system resources. Toolsets provided by commercial embedded operating systems are not easily changed.

Prior art solutions to this problem for using dual processors include having separate resources for each of the cores. This is not practical due to limited board space availability. Other prior art approaches include: Green Hills Dy4-182 BSP with Integrity 5.04. (Developed by Green Hills).

The Green Hills device offers dual processor Board Support Package (BSP) support for the Dy4-182 card, but their implementation is incomplete. The Green Hills Software BSP does not contain the Boot Sequencer. Green Hills has made an effort to incorporate multi processor support into their operating system (kernel) software. They have provided BSP Interface Functions. These interface functions need to be written with care because the operating system running on the “main” CPU needs to provide parameters for the “secondary” CPU boot-up. Green Hills has modified their interrupt controller for multi-processor support.

The solution provided by Green Hills is very rigid (in-flexible). It cannot be claimed as an Asymmetric multiprocessing solution because the two operating systems are totally dependent on each other. The kernel for both processors has to be loaded as a monolith image, thus, the kernel for “main” CPU copies the kernel for “secondary” CPU and provides the secondary CPU an “entry point”. Green Hills doesn't have the Boot Sequence piece required for secondary CPU boot-up.

The prior art implementations did not allow for independent operation of each processor, which requires overhead, and increases the complexity. Further, these systems require an OS on each processor that is modified to interact with the other processors, rather than using a traditional and proven OS operating independently. These methods also force compatible operating systems on each processors, rather than allowing for operating systems from different companies. The Green Hills tool for multiple processors does not support all of the functionality that is supported for a single processor. The tools have errors and are severely limited and broken (but not limited to) in the following areas:

Dual CPU code does not run out of flash;

cannot perform checksum of secondary kernel image;

cannot used “static” shared memory between different kernels; and

the created Integrate header file cannot be used for Dual Processors because the integrate file only has the objects from the second processor specified.

The prior art systems are deficient in solving the aforementioned problem because each operating system (kernel) does not operate within its own address space. The possibility exists for either kernel to corrupt the other. Further, the amount of cooperation required is difficult to attain. The secondary CPU is totally dependent on main CPU for kernel download, and entry point information. Cooperation must be kept to a minimum. Finally, there is a need for cooperation from operating systems from different vendors running on each CPU. Now it is impossible to have operating systems from different vendors resident on the card.

None of the prior art devices operate in the unique fashion as the present invention nor do they contain these unique features:
the interrupt controller uses minimal cooperation between operating systems;
each Operating System operates within its allocated memory space;
the ability to execute from Flash/ROM;
the ability to load each Operating System (kernel) separately; and
allows for “mix-n-match” configuration of Operating System for each CPU. Further, the prior art methods cause several of their tools to not function.

### SUMMARY OF THE INVENTION (DISCLOSURE OF THE INVENTION)

The present invention is a method and apparatus for providing operating systems running on two independent processors that share resources, namely a single memory space. The system is unique due to the independence between the two operating systems. The two operating systems share resources yet they do not interact with each other. The only change that needs to be made is to the interrupt vector code. By using this unique solution there is very little risk and is almost error free. Further, the solution maintains the same toolset that is used in single processor systems, and this toolset can be reused with no modifications. Finally, a generic boot code enables both processors to execute from the same reset vector in flash memory space.

A primary object of the present invention is to provide operating systems using two or more independent processors using a single memory space.

A primary advantage of the present invention is that having Kernel independence allows usage of same toolset.

Another advantage of the present invention is that each Kernel maintains its own interrupt vectors, while modifying only the primary vectors to redirect to the respective processor vectors.

Yet another advantage of the present invention is that it uses the same boot code for both processors.

Other objects, advantages, and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a block diagram showing the preferred embodiment of two processors combined with a single system controller.

FIG. 2 is an illustration of how RAM and flash memory is allocated between the two processors for the embodiment of FIG. 1.

FIG. 3 illustrates the starting sequence of the primary processor for the embodiment of FIG. 1.

FIG. 4 depicts the startup sequence of the secondary processor for the embodiment of FIG. 1.

FIG. 5 depicts the common interrupt vector code for both processors for the embodiment of FIG. 1.

FIG. 6 is a flow chart of the common boot code for both processors for the embodiment of FIG. 1.

### DESCRIPTION OF THE PREFERRED EMBODIMENTS (BEST MODES FOR CARRYING OUT THE INVENTION)

The present invention disclosed is an apparatus and method for cooperative asymmetric multiprocessing which allows for operating systems to function independently of each other on multiple processors sharing common resources in an embedded system.

The following terms are used in this disclosure and are defined below:

Boot Code: Code that runs at the reset vector.

Interrupt Vector: Each processor has a set of exceptions/interrupts that are located in specific memory locations.

Kernel: Could be a combination of the operating system and board support package code.

Interrupt Handlers: Code that is executed after a processor gets an interrupt/exception.

Processor and CPU can be used interchangeably.

Boot Sequencer: Synonym for Boot Code, Boot Strap

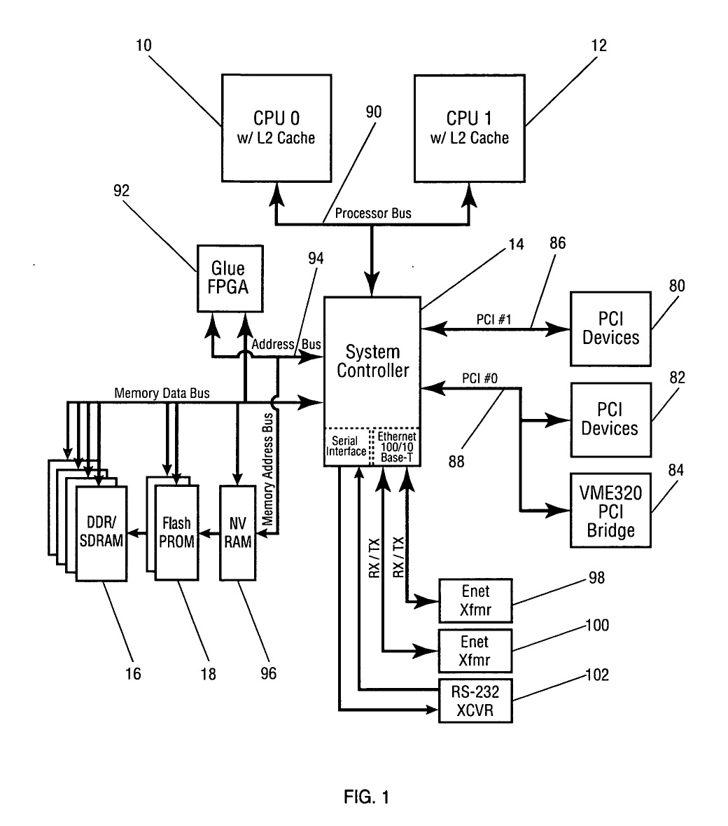

FIG. 1 is a multi processor system level block diagram of the preferred embodiment showing two processors 10 and 12 whose arbitration is managed by a single system controller 14. This figure depicts the single memory space, DDR/SDRAM 16 and Flash PROM 18 for both processors 10 and 12. The figure illustrates the fact that both processors 10 and 12 will have to share resources. This figure illustrates one embodiment of the present invention. The system can include more processors provided the system controller supports the additional processor arbitration. FIG. 1 also illustrates the fact that processors 10 and 12 share the same Reset Vector in Flash 18 and share the interrupt vector physical address in SDRAM 16.

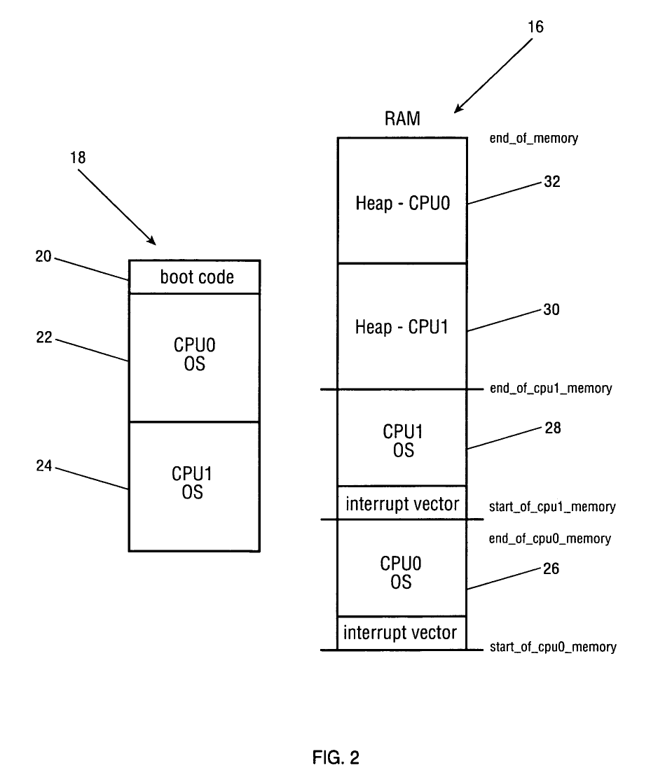

FIG. 2 is one illustration of memory allocation of RAM 16 and flash memory 18 between two processors 10 and 12. To maintain independence between the two processors there is allocated separate memory spaces for each of the processors. As seen in FIG. 2, the addresses are irrelevant. Both processors 10 and 12 share a common boot code 20 in flash memory 18. Each processor has an independent operating system 22 and 24 that executes independently out of RAM 26 and 28. Each processor also has its own independent heap space 30 32. The design is not limited to executing out of RAM 16. Both operating systems can execute out of flash 18.

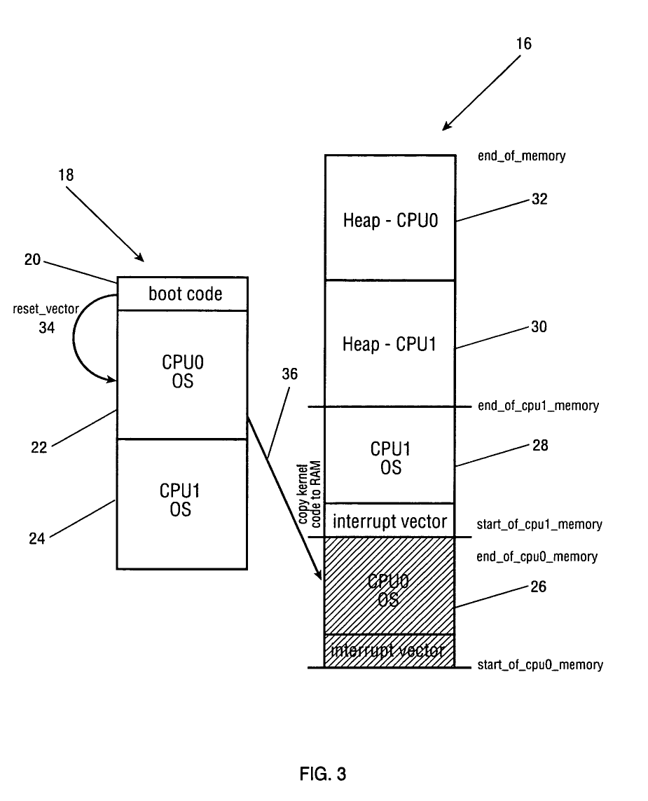

FIG. 3 illustrates the startup sequence of the primary processor CPU0 10. CPU0 10 starts in the common boot code 20 area then continues on to the CPU0's designated operating system entry point 34 in flash 18. CPU0 10 will copy the operating system (data and/or text*) to RAM 36 and execute out of CPU0's 10 designated area 26.

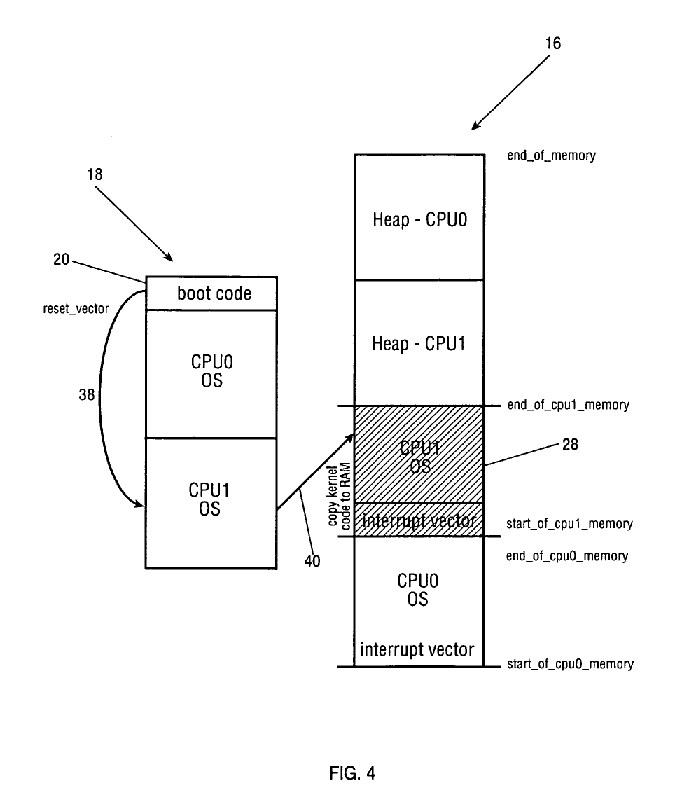

FIG. 4 depicts the startup sequence of the secondary processor CPU1 20. CPU1 20 starts in the common boot code 20 area as CPU0 10 then continues on to the CPU1's 20 designated operating system entry point 38 in flash 18. CPU1 20 will copy the operating system (data and/or text*) to RAM 40 and execute out of CPU1's 20 designated area 28. The secondary processor 20 is held in reset when the system starts and when it is taken out of reset by CPU0 10, CPU1 20 begin its startup sequence. This is how both processors are prevented from corrupting the system controller initialization.

FIGS. 3 and 4 show how each processor is responsible for copying its kernel (data and/or text*) and interrupt code into RAM memory 36 and 40. This distinction is very important because this separation is how the processors maintain independence.

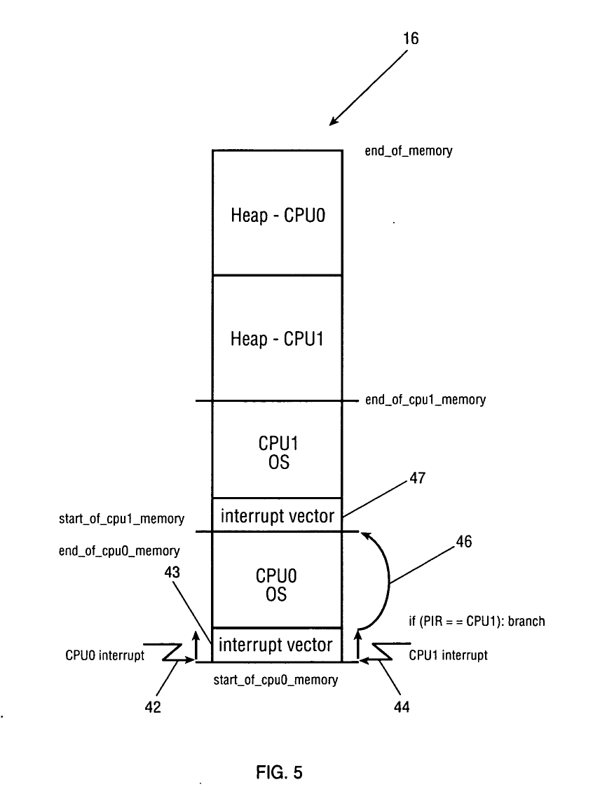

The interrupt vectors must reside at physical address zero because that is where the interrupt services routines are located in a PowerPC architecture. FIG. 5 depicts the preferred interrupt vectoring scheme for each processor 10 and 12 namely, “what happens when each processor gets an interrupt?” Interrupts are initiated 42 and 44 in a common memory area then split 46 to the appropriate range for that respective processor. The fact that all processors go to the same address on receiving an interrupt, as shown in FIG. 5, forces modifications to the vectoring code to support more than one processor. Each processor vectors to the same address in memory at this address a decision is made; “who am I?”

### If CPU0 10;

Execute handlers for CPU0 10 (continues in the original location); or

### If CPU1 12;

Branch to the address of CPU1 20 handlers; and

Execute handlers for CPU1 20.

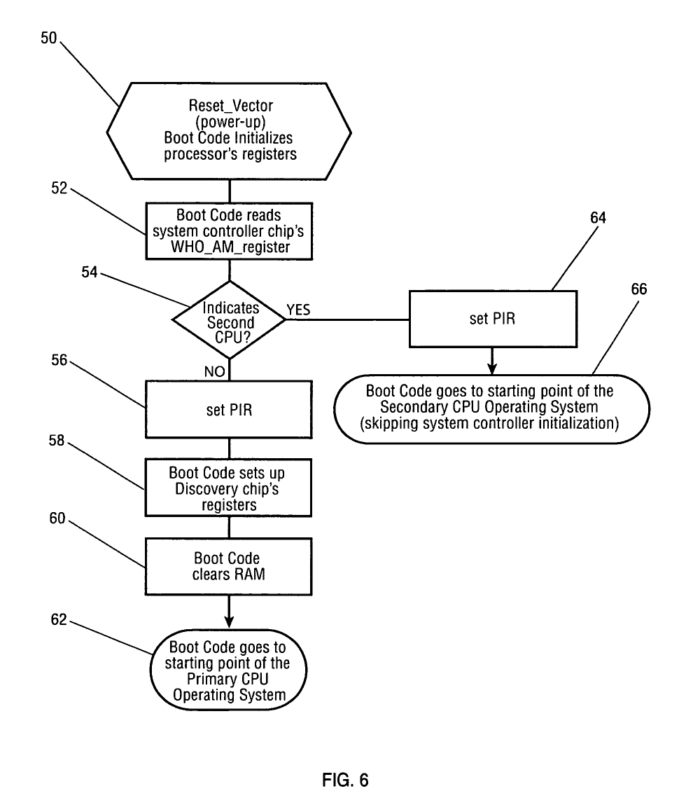

FIG. 6 is a flow chart of the common boot code flow for both processors 10 and 12. On power-on reset 50, the booting processor reads the identification register 52 to understand its role in the system. If the booting processor is the primary processor 54 then it sets its processor identification register to a first unique value 56, performs basic system controller initialization 58, clears RAM 60 and continues on to the entry point of its operating system code 62. If the booting processor is the secondary processor 54 then it sets its processor identification register to a second unique value 64, and continues on to the entry point of its operating system code 66. The processor in charge of system controller doesn't matter as long as the processors do not re-initialize these resources or try to use them before they are initialized.

It is important to note that when both ‘data and text’ (Data and/or Text*) are copied to RAM 16 the operating system is said to be executing out of RAM 16. When only ‘data’ is copied to RAM 16 the operating system is said to be executing from flash 18. This provides the feature of the design is in not limited to copying and executing out of RAM 16, but both operating systems can also execute out of flash 18.

Below are the steps for a typical implementation:

A) Create appropriate File Directory Structure

Make two redundant copies of the BSP/ and tools/ directory (one directory for each CPU). Each CPU directory will built totally independent of the other.

Example
cpu0/coreV3/bsp/
cpu0/coreV3/tools
cpu1/coreV3/bsp/
cpu1/coreV3/tools

B) Decide how Random Access Memory (RAM) will be shared between the two processors. Main CPU uses address 0x0-0x01FF_FFFF and secondary uses 0x0200_{—}0000 to 0x0400_{—}0000. Address ranges 0x0-0x3000 are shared by both processors. This is where the interrupt vectors reside. These operating ranges were picked because kernels cannot operate beyond the 26-bit addressing limitation set by PowerPC architecture.

Affected File/s for the Secondary CPU kernel

sysLib.c

VxWorks specifies the address ranges in sysLib.c file.

SysBatDPhysMemDesc[] is used to initialize the Page Table Entry (PTE) array.
Add address range 0x0-0x3000 as first entry in SysBatDPhysMemDesc[] array.

ipmv3.h
Change the kernel variables ramStart, ramEnd, by adding offset 0x0200_{—}0000. ramEnd limits the kernel from accessing memory beyond the specified size.

Makefile
Add the—mlongcall GNU option to bsp/Makefile. Allows kernel to perform branch long instructions.

C) Decide where the two kernel images are going to reside in Flash/ROM. Change the variables CPUX_VXWORKS_PROM_START, CPUx_APP_PROM_START, and CPUx_BOOT_PROM_START so that the tools/Makefile can build the respective images.

D) Boot Sequencer: Both the CPUs share boot code. The Primary CPU performs all system controller initialization, RAM clear and jumps to the start address of its kernel code. The secondary CPU reads the who_am_I register resident on the system controller and skips all initialization branching to the start address of its kernel code.

E) Interrupt Controller changes.

Affected File/s:
excArchLib.c
On the primary CPU,
   The excConnectCode[] array was modified to save the condition register and read the Processor Identification Register (PIR) before branching to the respective interrupt handler code.
   Macros ENT_OFF, INT_OFF, and EXIT_OFF were modified to reflect changes to the excConnectCode[] array.
On the secondary CPU,
   The offset (0x0200_{—}0000) was added to excVecBase global variable.
   The excConnectCode[] array was modified to remove redundant instructions already accounted for by Primary CPU.
   Macros ENT_OFF, INT_OFF, and EXIT_OFF were modified to reflect changes to the excConnectCode[] array.

excALib.s

intALib.s

The files excALib.s and intALib.s contained hard-coded “magic” numbers for the macro ENT_OFF. Had to change the number because of changes identified to the macro.

Makefile

The above mentioned files were copied from the WIND_BASE directory into local BSP/ directory and added to the bsp/Makefile.

F) Secondary CPU Boot up changes.

The Primary processor after it has finished initialization (booting vxWorks) will clear the BR1 Mask Bit in the System Controller to allow the secondary CPU to boot.

Affected File/s: usrAppInit.c

Although the figures depict a implementation using two processors, this disclosure is not limited to two processors. Multiple processors can be implemented in a similar manner; however, each processor is responsible for copying its code (text and/or data) into memory, and the interrupt vector code for primary processor would need to be modified to account for additional processors.

In using the present invention, there is minimal interaction between the kernels. Most of the separation is done in software by using build scripts. In real time operation, each processor reads the Processor Identification Register (PIR) or WHO_μM_I register to make decisions when it has to access a shared resource. The only code that requires modification is the one that resides at the interrupt vectors and, even here the system is not compromised because each processor uses its own set of registers during execution. System level decisions need to be made to determine which processor handles which events. For some I/O events such as VME it is desirable to have a single processor resolve interrupts, rather than both.

In a typical implementation the software algorithm at the interrupt vector address follows:

/********************************************/
Code copied by primary processor
/********************************************/
Save general purpose register
Save condition register
Save Link Register
Read PIR
If (PIR == CPU1)

Go to: CPU1_interrupt handler

Else (PIR == CPU0)
Execute CPU0_interrupt handler
Restore Link register
Restore Condition register
Restore General purpose register
Return
/********************************************/
Code copied by secondary processor
/********************************************/
CPU1_interrupt handler:
Execute CPU1_interrupt handler
Restore Link register
Restore Condition register
Restore General purpose register
Return

The current design is not limited to any type of processor. Switching processors changes the underlying assembly instructions that were used to develop the interrupt vector code. Each processor has different requirements as to what needs to happen at the interrupt vector; but, the basic invention of detecting which processor is in use (reading the PIR register for PowerPC) and making a decision doesn't change. The Operating System could be changed in a similar manner.

With multi-core processors just around the corner this implementation of dual processor design will be the stepping-stone to solve multi-core problems. Embedded processors are increasingly being used for Home Multimedia set top boxes. These applications have the same limitations to dissipate power, physical size, and fast startup. As the need for more performance increases in these applications the set top boxes will be forced to consider dual/multi processor/core designs. The present invention can be implemented in the next generation processors for the embedded market that are designed with multiple cores and system controllers to support multiple processors. Commercial Off the Shelf (COTS) boards with ruggedized designs will eventually use this new technology. These boards are used in a variety of applications, including simulation, heavy industry, and aerospace.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

What is claimed is:

1. A cooperative multiprocessing method that supports at least two distinct operating systems that share a single memory, the method comprising the steps of:
providing at least two embedded processors;
prioritizing an initialization sequence of the at least two processors;
allocating resources of the single memory depending on predetermined factors;
detecting a system interrupt in the single memory;
identifying each processor from the at least two processors; and
executing a correct interrupt handler.

2. The method of claim 1 wherein the step of prioritizing an initialization sequence comprises providing a start up sequence.

3. The method of claim 2 wherein the start up sequence comprises the substeps of:
starting a primary processor from the at least two processors at a reset vector in a flash memory;
performing a system initialization by the primary processor;
releasing a secondary processor from a reset;
starting the secondary processor at the reset vector; and
performing a system initialization by the secondary processor.

4. The method of claim 1 wherein the predetermined factors comprise an amount of memory available to allocate, an amount of memory to store the executables in each operating system, an amount of memory for the system interrupt for each operating system and an amount of heap space for each operating system.

5. The method of claim 1 wherein the step of allocating resources comprises evenly dividing an amount of memory between each of the operating systems.

6. The method of claim 1 wherein the step of allocating resources comprises unevenly dividing an amount of memory between each of the operating systems.

7. The method of claim 1 wherein the resources comprises providing at least one flash bank and at least one random access memory (RAM) bank.

8. The method of claim 1 further comprising the step of designating a master processor from the at least two embedded processors for shared resource.

9. An embedded cooperative multiprocessing system that supports at least two distinct operating systems that share a single memory comprising:
at least two processors;
a set of predetermined shared resources;
a means for prioritizing an initialization sequence of the at least two processors;
a means for allocating said predetermined shared resources of the single memory depending on predetermined factors;
a means for detecting a system interrupt in the single memory;
a means for identifying each processor from the at least two processors; and
a means for executing a correct interrupt handler.

10. The embedded cooperative multiprocessing system of claim 9 wherein the predetermined factors comprise an amount of memory available to allocate, an amount of memory to store the executables in each operating system, an amount of memory for the system interrupt for each operating system and an amount of heap space for each operating system.

11. The embedded cooperative multiprocessing system of claim 9 wherein the means for allocating resources comprises a means for evenly dividing an amount of memory between each of the operating systems.

12. The embedded cooperative multiprocessing system of claim 9 wherein the means for allocating resources comprises a means for unevenly dividing an amount of memory between each of the operating systems.

13. The embedded cooperative multiprocessing system of claim 9 wherein the resources comprises at least one flash bank and at least one random access memory (RAM) bank.

14. The embedded cooperative multiprocessing system of claim 13 wherein resources comprises separate resources for each operating system.

15. The embedded cooperative multiprocessing system of claim 9 further comprising a master processor from the at least two embedded processors for a shared resource.
